(19) United States
(12) Patent Application Publication
(10) Pub. No.: US 2001/0037821 A1
(43) Pub. Date: Nov. 8, 2001

(54) Integrated chemical-mechanical polishing

(76) Inventors: Bradley J. Staley, Austin, TX (US); Gregory H. Bogush, Aurora, IL (US); Jeffrey P. Chamberlain, Aurora, IL (US); Paul M. Feeney, Aurora, IL (US); Alicia F. Walters, Naperville, IL (US); Steven K. Grumbine, Aurora, IL (US); Brian L. Mueller, Chandler, AZ (US); David J. Schroeder, Aurora, IL (US)

Correspondence Address: PHYLLIS T. TURNER-BRIM, ESQ., LAW DEPARTMENT, CABOT MICROELECTRONICS CORPORATION, 870 NORTH COMMONS DRIVE, AURORA, IL, 60504, US

(21) Appl. No.: 09/829,101

(22) Filed: Apr. 9, 2001

Related U.S. Application Data
(60) Provisional application No. 60/195,744, filed on Apr. 7, 2000.

(51) Int. Cl. B08B 3/04; B08B 9/20

(52) U.S. Cl. 134/25.4; 134/36

(57) ABSTRACT

The present invention provides a method of polishing and/or cleaning a substrate using a multi-component polishing and/or cleaning composition, wherein the components of the polishing and/or cleaning composition are mixed at the point-of-use or immediately before delivery to the point-of-use. The present invention also provides a method of polishing and/or cleaning more than one substrate simultaneously using a single apparatus, wherein a different polishing or cleaning composition is delivered to each substrate.

### CROSS-REFERENCE TO RELATED PATENT APPLICATIONS

This patent application claims priority to provisional U.S. patent application Ser. No. 60/195,744 filed on Apr. 7, 2000.

### TECHNICAL FIELD OF THE INVENTION

This invention pertains to a method and apparatus for polishing and/or cleaning a substrate using a multi-component polishing and/or cleaning composition.

### BACKGROUND OF THE INVENTION

Effective planarization or polishing of a substrate typically involves the use of one or more multi-component compositions. Chemical-mechanical polishing (CMP) processes, for example, involve the use of a polishing composition and optionally the use of a cleaning composition, in order to remove slurry and substrate remnants from the surface of the polished substrate.

Conventional CMP processes involve the use of premixed bulk compositions. Polishing compositions and/or cleaning compositions are purchased and stored in bulk containers, and are delivered when needed through appropriate apparatus to the desired point of use. There are several drawbacks to this conventional approach. In particular, bulk compositions must be produced such that they can be stored in a stable manner for prolonged periods of time prior to use. As a result, the effectiveness of conventional multi-component compositions is sometimes compromised in favor of producing more stable, but less optimum, combinations of components. Additionally, dynamic changes of composition chemistry are rarely feasible using pre-mixed multi-component compositions. In particular, it is not possible to change the formulation of the polishing composition and/or cleaning composition during the polishing or cleaning process.

Accordingly, a need remains for a method and/or apparatus for providing a dynamic, integrated polishing and/or cleaning process that enables optimization of the manufacturing of substrates, for example semiconductor devices and memory or rigid disks. The present invention seeks to provide such a method and apparatus. These and other advantages of the present invention will be apparent from the description of the invention provided herein.

### BRIEF SUMMARY OF THE INVENTION

The present invention provides a method of polishing and/or cleaning a substrate using a multi-component polishing and/or cleaning composition, wherein the components of the polishing and/or cleaning composition are mixed at the point-of-use, or immediately before delivery to the point-of-use. The present invention also provides a method of polishing and/or cleaning more than one substrate simultaneously using a single apparatus, wherein a different polishing or cleaning composition is delivered to each substrate.

### DETAILED DESCRIPTION OF THE INVENTION

The present invention provides a method of polishing and/or cleaning a substrate using a multi-component polishing and/or cleaning composition. The present invention also provides a method of polishing and/or cleaning more than one substrate simultaneously using a single apparatus. The components of the polishing and/or cleaning composition can be mixed at the point-of-use or immediately before delivery to the point-of-use. Alternatively, or in addition, a different polishing or cleaning composition is delivered to each substrate.

The terms “polish” and “planarize” are used interchangeably to refer to the removal of material from a substrate. The term “component” as used herein includes individual ingredients (e.g., acids, bases, oxidizers, water, etc.) or any combination of ingredients (e.g., aqueous compositions, abrasive slurries, mixtures and solutions of oxidizers, acids, bases, complexing agents, etc.) that can be stored separately and combined at, or immediately before, the point-of-use to form a polishing or cleaning composition. The term “point-of-use” refers to the point at which the composition is applied to the substrate surface (e.g., the polishing pad or the substrate surface itself). The substrates, ingredients of the polishing or cleaning compositions, polishing or cleaning compositions, and apparatus that can be used in conjunction with the present invention are discussed below.

### Substrate

The present invention can be used in conjunction with any suitable substrate. Suitable substrates comprise, for example, a metal, metal oxide, metal composite, or mixtures thereof. The substrate can comprise, consist essentially of, or consist of any suitable metal. Suitable metals include, for example, copper, aluminum, titanium, tungsten, tantalum, gold, platinum, iridium, ruthenium, and combinations (e.g., alloys or mixtures) thereof. The substrate also can comprise, consist essentially of, or consist of any suitable metal oxide. Suitable metal oxides include, for example, alumina, silica, titania, ceria, zirconia, germania, magnesia, and coformed products thereof, and mixtures thereof. In addition, the substrate can comprise, consist essentially of, or consist of any suitable metal composite and/or metal alloy. Suitable metal composites and metal alloys include, for example, metal nitrides (e.g., tantalum nitride, titanium nitride, and tungsten nitride), metal carbides (e.g., silicon carbide and tungsten carbide), nickel-phosphorus, alumino-borosilicate, borosilicate glass, phosphosilicate glass (PSG), borophosphosilicate glass (BPSG)), silicon/germanium alloys, and silicon/germanium/carbon alloys. The substrate also can comprise, consist essentially of, or consist of any suitable semiconductor base material. Suitable semiconductor base materials include single-crystal silicon, poly-crystalline silicon, amorphous silicon, silicon-on-insulator, and gallium arsenide. Glass substrates can also be used in conjunction with the present invention including technical glass, optical glass, and ceramics, of various types known in the art.

In particular, the present invention can be used in conjunction with memory or rigid disks, metals (e.g., noble metals), ILD layers, integrated circuits, semiconductor devices, semiconductor wafers, micro-electro-mechanical systems, ferroelectrics, magnetic heads, polymeric films, and low and high dielectric constant films, and technical or optical glass. The present method is especially useful in polishing or planarizing a semiconductor device, for example, semiconductor devices having device feature geometries of about 0.25 μm or smaller (e.g., 0.18 μm or smaller). The term “device feature” as used herein refers to a single-function component, such as a transistor, resistor, capacitor, integrated circuit, or the like. As device features of the semiconductor substrate become increasingly small, the degree of planarization becomes more critical. A surface of a semiconductor device is considered to be sufficiently planar when the dimensions of the smallest device features (e.g., device features of 0.25 μm or smaller, such as device features of 0.18 μm or smaller) can be resolved upon the surface via photolithography. The planarity of the substrate surface also can be expressed as a measure of the distance between the topographically highest and lowest points on the surface. In the context of semiconductor substrates, the distance between the high and low points on the surface desirably is less than about 2000 Å, preferably less than about 1500 Å, more preferably less than about 500 Å, and most preferably less than about 100 Å.

The present invention can be used to polish any part of a substrate (e.g., a semiconductor device) at any stage in the production of the substrate. For example, the present invention can be used to polish a semiconductor device in conjunction with shallow trench isolation (STI) processing, as set forth, for example, in U.S. Pat. Nos. 5,498,565, 5,721,173, 5,938,505, and 6,019,806, or in conjunction with the formation of an interlayer dielectric.

### Polishing and Cleaning Components

The present invention can be used in conjunction with any suitable component (or ingredient) known in the art, for example, abrasives, oxidizing agents, catalysts, film-forming agents, complexing agents, rheological control agents, surfactants (i.e., surface-active agents), polymeric stabilizers, pH-adjusters, and other appropriate ingredients.

Any suitable abrasive can be used in conjunction with the present invention. Suitable abrasives include, for example, metal oxide abrasives. Suitable metal oxide abrasives include, for example, alumina, silica, titania, ceria, zirconia, and magnesia, and coformed products thereof, and mixtures thereof, and chemical admixtures thereof. The term “chemical admixture” refers to particles including atomically mixed or coated metal oxide abrasive mixtures. Suitable abrasives also include heat-treated abrasives and chemically-treated abrasives (e.g., abrasives with chemically-linked organic functional groups).

The abrasive can be produced by any suitable technique known to one of ordinary skill in the art. The abrasive can be derived, for example, from any process set forth in U.S. Pat. No. 6,015,506, including flame processes, sol-gel processes, hydrothermal processes, plasma processes, aerogel processes, fuming processes, precipitation processes, mining, and combinations of processes thereof. Moreover, the abrasive can be a condensation-polymerized metal oxide, e.g., condensation-polymerized silica, as disclosed in the U.S. patent application Ser. No. 09/440,525. A suitable abrasive also can comprise, consist essentially of, or consist of high-temperature crystalline phases of alumina consisting of gamma, theta, delta, and alpha alumina, and/or low-temperature phases of alumina consisting of all non-high temperature crystalline alumina phases. Also suitable for use in conjunction with the present invention are abrasives prepared in accordance with U.S. Pat. No. 5,230,833 and various commercially available products, such as the Akzo-Nobel Bindzil 50/80 product and the Nalco 1050, 2327, and 2329 products, as well as other similar products available from DuPont, Bayer, Applied Research, Nissan Chemical, and Clariant.

The abrasive can be combined with any suitable carrier (e.g., an aqueous carrier) to form a “dispersion” (i.e., a “slurry”). Suitable dispersions can have any suitable concentration of abrasive.

The abrasive can have any suitable abrasive particle characteristics depending on the desired polishing effects. In particular, the abrasive can have any suitable surface area. A suitable abrasive surface area, for example, is a surface area ranging from about 5 m²/g to about 430 m²/g, as calculated from the method of S. Brunauer, P. H. Emmet, and I. Teller, J. Am. Chemical Society, 60, 309 (1938). Moreover, the abrasive of the composition used in conjunction with the present invention can be mono-disperse in abrasive particle size distribution, as set forth, for example, in U.S. Pat. No. 5,993,685. Alternatively, it is also suitable for the abrasive to be essentially bimodal in particle size distribution, as set forth, for example, in U.S. patent application Ser. No. 09/440,525. The abrasive used in conjunction with the present invention can be characterized by any suitable packing density. A suitable abrasive packing density, for example, is set forth in U.S. patent application Ser. No. 09/440,525. It is also suitable for the abrasive used in conjunction with the present invention to be characterized by a particular surface hydroxyl group density, as set forth, for example, in U.S. patent application Ser. No. 09/737,905.

Any suitable oxidizing agent can be used in conjunction with the present invention. Suitable oxidizing agents include, for example, oxidized halides (e.g., chlorates, bromates, iodates, perchlorates, perbromates, periodates, fluoride-containing compounds, and mixtures thereof, and the like). Suitable oxidizing agents also include, for example, perboric acid, perborates, percarbonates, nitrates (e.g., iron (III) nitrate, and hydroxylamine nitrate), persulfates (e.g., ammonium persulfate), peroxides, peroxyacids (e.g., peracetic acid, perbenzoic acid, m-chloroperbenzoic acid, salts thereof, mixtures thereof, and the like), permanganates, chromates, cerium compounds, ferricyanides (e.g., potassium ferricyanide), mixtures thereof, and the like. It is also suitable for the composition used in conjunction with the present invention to contain oxidizing agents as set forth, for example, in U.S. Pat. No. 6,015,506.

Any suitable catalyst can be used in conjunction with the present invention. Suitable catalysts include metallic catalysts, non-metallic catalysts, and combinations thereof. The catalyst can be selected from metal compounds that have multiple oxidation states, such as but not limited to Ag, Co, Cr, Cu, Fe, Mo, Mn, Nb, Ni, Os, Pd, Ru, Sn, Ti, and V. The term “multiple oxidation states” refers to an atom and/or compound that has a valence number that is capable of being augmented as the result of a loss of one or more negative charges in the form of electrons. Iron catalysts include, but are not limited to, inorganic salts of iron, such as iron (II or III) nitrate, iron (II or III) sulfate, iron (II or III) halides, including fluorides, chlorides, bromides, and iodides, as well as perchlorates, perbromates, and periodates, and ferric organic iron (II or III) compounds such as but not limited to acetates, acetylacetonates, citrates, gluconates, oxalates, phthalates, and succinates, and mixtures thereof.

Any suitable film-forming agent (i.e., corrosion-inhibitor) can be used in conjunction with the present invention. Suitable film-forming agents include, for example, heterocyclic organic compounds (e.g., organic compounds with one or more active functional groups, such as heterocyclic rings, particularly nitrogen-containing heterocyclic rings). Suitable film-forming agents include, for example, benzotriazole, triazole, benzimidazole, and mixtures thereof, as set forth in U.S. patent application Ser. No. 09/442,217.

Any suitable complexing agent (i.e., chelating agent or selectivity enhancer) can be used in conjunction with the present invention. Suitable complexing agents include, for example, carbonyl compounds (e.g., acetylacetonates and the like), simple carboxylates (e.g., acetates, aryl carboxylates, and the like), carboxylates containing one or more hydroxyl groups (e.g., glycolates, lactates, gluconates, gallic acid and salts thereof, and the like), di-, tri-, and poly-carboxylates (e.g., oxalates, phthalates, citrates, succinates, tartrates, malates, edetates (e.g., disodium EDTA), mixtures thereof, and the like), carboxylates containing one or more sulfonic and/or phosphonic groups, and carboxylates as set forth, for example, in U.S. patent application Ser. No. 09/405,249. Suitable chelating or complexing agents also can include, for example, di-, tri-, or poly-alcohols (e.g., ethylene glycol, pyrocatechol, pyrogallol, tannic acid, and the like) and phosphate-containing compounds, e.g., phosphonium salts, and phosphonic acids, as set forth, for example, in U.S. patent application Ser. No. 09/405,249. Complexing agents can also include amine-containing compounds (e.g., amino acids, amino alcohols, di-, tri-, and poly-amines, and the like). Examples of amine-containing compounds include methylamine, dimethylamine, trimethylamine, ethylamine, diethylamine, triethylamine, ethanolamine, diethanolamine, diethanolamine cocate, triethanolamine, isopropanolamine, diisopropanolamine, triisopropanolamine, nitrosodiethanolamine, and mixtures thereof. Suitable amine-containing compounds further include ammonium salts (e.g., TMAH and quaternary ammonium compounds). The amine-containing compound also can be any suitable cationic amine-containing compound, such as, for example, hydrogenated amines and quaternary ammonium compounds, that adsorbs to the silicon nitride layer present on the substrate being polished and reduces, substantially reduces, or even inhibits (i.e., blocks) the removal of silicon nitride during polishing.

Any suitable surfactant and/or rheological control agent can be used in conjunction with the present invention, including viscosity enhancing agents and coagulants. Suitable Theological control agents include, for example, polymeric Theological control agents. Moreover, suitable rheological control agents include, for example, urethane polymers (e.g., urethane polymers with a molecular weight greater than about 100,000 Daltons), and acrylates comprising one or more acrylic subunits (e.g., vinyl acrylates and styrene acrylates), and polymers, copolymers, and oligomers thereof, and salts thereof. Suitable surfactants include, for example, cationic surfactants, anionic surfactants, anionic polyelectrolytes, nonionic surfactants, amphoteric surfactants, fluorinated surfactants, mixtures thereof, and the like.

The composition used in conjunction with the present invention can contain any suitable polymeric stabilizer or other surface active dispersing agent, as set forth, for example, in U.S. patent application Ser. No. 09/440,401. Suitable polymeric stabilizers include, for example, phosphoric acid, organic acids, tin oxides, organic phosphonates, mixtures thereof, and the like.

It will be appreciated that many of the aforementioned compounds can exist in the form of a salt (e.g., a metal salt, an ammonium salt, or the like), an acid, or as a partial salt. For example, citrates include citric acid, as well as mono-, di-, and tri-salts thereof; phthalates include phthalic acid, as well as mono-salts (e.g., potassium hydrogen phthalate) and di-salts thereof; perchlorates include the corresponding acid (i.e., perchloric acid), as well as salts thereof. Furthermore, the compounds recited herein have been classified for illustrative purposes; there is no intent to limit the uses of these compounds. As those of skill in the art will recognize, certain compounds may perform more than one function. For example, some compounds can function both as a chelating and an oxidizing agent (e.g., certain ferric nitrates and the like).

Any of the components used in conjunction with the present invention can be provided in the form of a mixture or solution in an appropriate carrier liquid or solvent (e.g., water or an appropriate organic solvent). Furthermore, as mentioned, the compounds, alone or in any combination, can be used as a component of a polishing or cleaning composition. Two or more components then are individually stored and subsequently mixed to form a polishing or cleaning composition at, or immediately before reaching, the point-of-use. A component can have any pH appropriate in view of the storage and contemplated end-use, as will be appreciated by those of skill in the art. Moreover, the pH of a component used in conjunction with the present invention can be adjusted in any suitable manner, e.g., by adding a pH adjuster, regulator, or buffer. Suitable pH adjusters, regulators, or buffers include acids, such as, for example, hydrochloric acid, acids such as mineral acids (e.g., nitric acid, sulfuric acid, phosphoric acid), and organic acids (e.g., acetic acid, citric acid, malonic acid, succinic acid, tartaric acid, and oxalic acid). Suitable pH adjusters, regulators, or buffers also include bases, such as, for example, inorganic hydroxide bases (e.g., sodium hydroxide, potassium hydroxide, ammonium hydroxide, and the like) and carbonate bases (e.g., sodium carbonate and the like).

### Polishing and Cleaning Compositions

The polishing and cleaning components described herein can be combined in any manner and proportion to provide one or more compositions suitable for polishing or cleaning a substrate (e.g., a semiconductor substrate). Suitable polishing compositions are set forth, for example, in U.S. Pat. Nos. 5,116,535, 5,246,624, 5,340,370, 5,476,606, 5,527,423, 5,575,885, 5,614,444, 5,759,917, 5,767,016, 5,783,489, 5,800,577, 5,827,781, 5,858,813, 5,868,604, 5,897,375, 5,904,159, 5,954,997, 5,958,288, 5,980,775, 5,993,686, 6,015,506, 6,019,806, 6,033,596, and 6,039,891, as well as in WO 97/43087, WO 97/47030, WO 98/13536, WO 98/23697, and WO 98/26025. Suitable cleaning compositions are set forth, for example, in U.S. Pat. No. 5,837,662 and U.S. patent application Ser. No. 09/405,249.

### Component Storage

The present invention utilizes at least two, and preferably more than two (e.g., 3 or more, 4 or more, or even 5 or more) storage devices in which the components of the polishing or cleaning composition are stored until use. Thus, each storage device contains one component of the polishing or cleaning composition used to polish the substrate. As previously mentioned, a “component” of the polishing or cleaning composition, as that term is used herein, can be any single compound or ingredient of the polishing or cleaning composition, or any combination of more than one such compound or ingredient. For example, the storage devices used to deliver a polishing or cleaning composition comprising hydrogen peroxide, a complexing agent, a film forming agent, and an abrasive could be configured in several ways. One configuration could include one storage device containing hydrogen peroxide, a second storage device containing the complexing agent and a film forming agent, and a third storage device containing an abrasive slurry. An alternative configuration could comprise one storage device comprising hydrogen peroxide, the complexing agent, and the film forming agent, and a second storage device containing an abrasive slurry. Yet another configuration could include a separate storage device for each of the ingredients.

The storage device can be any suitable size and shape for the storage of the components (e.g., liquid components). The devices used can be rigid, flexible, or even elastic to varying degrees. Furthermore, the storage devices can have an interior pressure equal to atmospheric pressure, or the storage device can be pressurized or evacuated before or after they are filled with a component. Examples of such storage devices include cylindrical, spherical, or rectangular containers, pistons, balloons, pressurized or evacuated tanks, bags, envelopes, packets, or other suitably shaped containers known in the art.

The storage devices can be made from any suitable material known in the art. As those of ordinary skill in the art will appreciate, the material used will depend on the particular component contained therein. In particular, the storage device (e.g., the exposed interior surface of the storage device) must be made from a material that will not react (e.g., soften, corrode, dissolve, etc.) in the presence of the particular component contained therein. Preferably, the material used will be compatible with more than one component of the polishing or cleaning composition. Suitable materials will include various plastics, metals, metal-alloys, and other materials known in the art.

### Component Flow Paths

The present invention utilizes one or more flow lines leading from each storage device to the point-of-use of the polishing slurry (e.g., the platen, the polishing pad, or the substrate surface). By the term “flow line” is meant a path of flow from an individual storage container to the point-of-use of the component stored therein. The one or more flow lines can each lead directly to the point-of-use, or, in the case that more than one flow line is used, two or more of the flow lines can be combined at any point into a single flow line that leads to the point-of-use. Furthermore, any of the one or more flow lines (e.g., the individual flow lines or a combined flow line) can first lead to one or more of the other devices (e.g., pumping device, measuring device, mixing device, etc.) prior to reaching the point-of-use of the component(s).

Thus, one or more flow lines can lead from a storage device to two or more points-of-use (e.g., two or more platens, two or more polishing pads, or two or more substrate surfaces). In this regard, it is suitable, for example, for multi-component polishing and/or cleaning compositions delivered to at least two substrates to be the same or different polishing and/or cleaning compositions and to have at least one component in common delivered from the same storage device. Similarly, it is suitable for polishing and/or cleaning compositions delivered to at least two substrates to be the same or different polishing and/or cleaning compositions and to have to have at least two (e.g., at least three, at least four, or even at least five) components in common delivered from the same storage devices.

The flow lines can comprise any combination of tubes, pipes, troughs, or containers. Preferably the flow lines comprise, or consist essentially of, tubes or pipes. Such tubes or pipes can have any cross sectional size (e.g., any cross sectional diameter) or shape (e.g., circular, elliptical, or polygonal) suitable for the delivery of the component to the point-of-use. The cross-sectional diameter of the flow line will depend, in part, on the particular component being transported thereby. For example, abrasive components (e.g., solid/liquid mixtures) might require larger flow line diameters than pure liquid components. Furthermore, the size of the flow line will depend, in part, on the amount of material to be transported thereby. For example, for polishing processes that require larger amounts of an abrasive component, a larger flow line for the abrasive component can be used. The size and shape of each of the flow lines, therefore, can be different.

The flow lines can be made from any suitable material for delivering the component to the point of use. As those of ordinary skill in the art will appreciate, the material used will depend, in part, on the particular component delivered therein. In particular, the flow lines (e.g., the exposed interior surfaces of the flow lines) must be made from a material that will not react (e.g., soften, dissolve, corrode, harden, etc.) in the presence of the particular component transported thereby. Preferably, the material used will be compatible with more than one component of the polishing or cleaning composition (e.g., compatible with all components of the polishing or cleaning composition). More preferably, the interior surfaces of the flow lines can comprise a material that facilitates the rapid and/or smooth flow of the components being transported therein. Suitable materials include various plastics, silicones, metals, metal-alloys, and other materials known in the art.

### Component Flow Control

The present invention preferably utilizes one or more flow valves that control the flow of the component from the storage device to the point-of-use. The flow valves can be part of the storage device or situated anywhere along the flow path from the storage device to the point of use. The flow valves can be adjusted (e.g., opened or closed) to any varying degree and can be operated manually, or, preferably, are connected to the control device (described below) (e.g., via electrical or electromechanical connections), which allows the flow valves to be operated centrally or even automatically. Thus, the system can be operated so as to provide the components to the point-of-use continuously, or by interrupting the flow periodically. For example, the components can be continuously delivered to a mixing device, wherefrom the mixed components are continuously delivered to the point-of-use. Alternatively, the components can be delivered to a mixing device periodically, wherefrom the mixed components are delivered to the point-of-use periodically, as in a batch or quasi-batch mixing and delivery process. Other alternative methods of delivering the components to the point-of-use are equally apparent using this system, for instance, by providing any one or more of the components directly to the point-of-use as a continuous or interrupted flow, wherein the components are mixed at the point-of-use. The flow valves can allow one way flow or two-way flow and can be of any suitable valve type known in the art.

### Pumping Device

The delivery of the components of the polishing slurry from the storage containers to the point-of-use can be carried out without a pumping device, for example, by using a gravity-feed mechanism of delivery (e.g., by placing the storage tanks higher than the point-of-use). However, the present invention preferably utilizes at least one pumping device to facilitate the transport of the components from the storage containers to the point-of-use via the flow lines. Any suitable pumping device can be used, for example, a diaphragm pump, a vacuum pump (e.g., to evacuate the system and “pull” the components from the storage tanks through the flow lines), an air pump (e.g., to pressurize the system or to drive a Ventura flow mechanism), a peristaltic pump, an impeller or fluid-turbine type pump, a hydraulic pump (e.g., piston or other device designed to create and/or maintain pressure in the system), or other suitable pumping devices known in the art. The pumping device can be provided as a separate element or can be part of one or more existing elements. For example, a storage device comprising a piston or a pressurized storage container (e.g., a pressurized tank or balloon), can serve as both a storage device for a component of the polishing or cleaning composition and a pumping device. Furthermore, the present invention can utilize more than one pumping device (e.g., more than one type of pumping device and/or a separate pumping device for each component).

### Component Metering

The present invention preferably utilizes at least one metering or measuring device to control the amount of each component (e.g, to control the ratio of individual components) provided to the point-of-use. A single measuring device can be used to measure the components individually, or several measuring devices can be used (e.g., a single measuring device for each component). In addition to one or more measuring devices used for determining the amount of each component being delivered, the apparatus can comprise a separate measuring device for determining the amount of any two or more components, and/or the total amount of slurry (e.g., all components combined), provided to the point-of-use.

The measuring device used in conjunction with the present invention can be any suitable measuring device known in the art. For example, the measuring device can be a container or, preferably, a flow meter from which the amount of component flowing through the flow lines can be calculated. Any suitable flow meter known in the art may be used, such as flywheel and rotor type flow meters. Non-contacting flow meters are preferred for measuring the flow of components that might corrode or wear a contacting flow meter (e.g., abrasive components). Such non-contacting flow meters include electromagnetic flow meters, ultrasonic flow meters, thermal dispersion flow meters, vortex shedding meters, rotameters with Hall effect electronic transducers, and coriolis mass flow meters.

### Component Mixing

The components of the polishing or cleaning composition can be delivered to the point-of-use independently (e.g., the components are delivered to the substrate surface whereupon the components are mixed during the polishing process), or the components can be combined immediately before delivery to the point-of-use. Components are combined “immediately before delivery to the point-of-use” if they are combined less than 10 seconds prior to reaching the point-of-use, preferably less than 5 seconds prior to reaching the point-of-use, more preferably less than 1 second prior to reaching the point of use, or even simultaneous to the delivery of the components at the point-of-use (e.g., the components are combined at a dispenser). Components also are combined “immediately before delivery to the point-of-use” if they are combined within 5 m of the point-of-use, such as within 1 m of the point-of-use or even within 10 cm of the point-of-use (e.g., within 1 cm of the point of use).

When two or more of the components are combined prior to reaching the point-of-use, the components can be combined in the flow line and delivered to the point-of-use without the use of a mixing device. Alternatively, one or more of the flow lines can lead into a mixing device to facilitate the combination of two or more of the components. Any suitable mixing device can be used. For example, the mixing device can be a nozzle or jet (e.g., a high pressure nozzle or jet) through which two or more of the components flow. Alternatively, the mixing device can be a container-type mixing device comprising one or more inlets by which two or more components of the polishing slurry are introduced to the mixer, and at least one outlet through which the mixed components exit the mixer to be delivered to the point-of-use, either directly or via other elements of the apparatus (e.g., via one or more flow lines). Furthermore, the mixing device can comprise more than one chamber, each chamber having at least one inlet and at least one outlet, wherein two or more components are combined in each chamber. If a container-type mixing device is used, the mixing device preferably comprises a mixing mechanism to further facilitate the combination of the components. Mixing mechanisms are generally known in the art and include stirrers, blenders, agitators, paddled baffles, gas sparger systems, vibrators, etc.

### Process Sensors

The present invention preferably utilizes sensors for monitoring the parameters of the polishing process. Examples of such sensors include pH sensors, flow monitors, temperature sensors, pressure sensors, speed sensors, infrared spectroscopy, fluorescence spectroscopy, and endpoint detection sensors, of various types known in the art. The present invention preferably utilizes at least one flow monitor capable of monitoring the flow of each component delivered to the point-of-use, more preferably a separate flow monitor for each component. The present invention also preferably utilizes sensors to allow the dynamic (e.g., real-time) monitoring of, and, thus, the dynamic control over, the substrate surface and the polishing or cleaning solution being used. In this way, higher polishing performance can be achieved by detecting changes in the polishing or cleaning conditions as the process proceeds (e.g., to eliminate dishing and within die non-uniformity) or as the process reaches the end-point (e.g., end-point detection to achieve appropriate polishing depth). For example, sensors can determine the thickness of the substrate or any part thereof (e.g., using radiation, laser, or light-type detection devices), determine a change in the pH of the polishing or cleaning composition (e.g., by using pH sensors), detect changes in the friction or torque between the polishing pad and the substrate (e.g., by detecting a change in the current flow on the platen or carrier drive motors), and/or detect changes in the electrical conductivity of the substrate (e.g., via electrodes measuring the current flow through the substrate).

### Component Dispenser

The present invention utilizes at least one dispenser, which simultaneously or sequentially dispenses one or more components from the flow lines onto the polishing surface (e.g., the substrate surface or the polishing pad). A single dispenser can be used, from which a single component or any combination of components of the polishing and/or cleaning compositions can be dispensed. Alternatively, the present invention can utilize more than one dispenser from which the components of the polishing and/or cleaning compositions are independently dispensed (e.g., one dispenser for each component). Preferably, however, the present invention utilizes more than one dispenser from each of which different combinations or ratios of components can be dispensed. For example, two or more dispensers can be utilized, each delivering slightly or completely different components or combinations of components simultaneously or sequentially to the same polishing surface. More preferably, each of these dispensers can be controlled independently (e.g., the rate of flow of each can be independently controlled).

### Polishing Station

The apparatus of the present invention preferably comprises at least one polishing station, preferably two or more polishing stations (e.g., four or more polishing stations).

The present invention preferably utilizes more than one polishing station (i.e., polishing tool) such that each polishing station has any combination of dispensers. The polishing stations can be controlled in parallel (e.g., the same parameters provided for each polishing station) or the polishing stations can be controlled independently (e.g., different parameters provided for each station). Thus, for example, a three-station system could simultaneously or sequentially provide for ILD polishing on one station, STI polishing on a second station, and a cleaning operation on the third station. Thus, the present invention preferably allows for the delivery of a different polishing or cleaning composition to each polishing station. Each polishing station typically comprises, among other elements known in the art, a platen and a drive motor for the platen, a carrier and a drive motor for the carrier, and a polishing pad. Any suitable platen, carrier, and drive motor can be used. Preferably, the drive motors are capable of communicating with a controlling device so as to be centrally or automatically controlled during the polishing process (e.g., in response to changing conditions during the polishing process).

Any suitable polishing pad can be used in conjunction with the present invention. In particular, the polishing pad can be woven or non-woven and can comprise any suitable polymer of varying density, hardness, thickness, compressibility, ability to rebound upon compression, and compression modulus. The polishing pad used in conjunction with the present invention preferably has a density of about 0.6-0.95 g/cm³, a Shore A hardness rating of less than about 100 (e.g., about 40-90), a thickness of at least about 0.75 mm (e.g., about 0.75-3 mm), compressibility of about 0-10% (by volume), the ability to rebound to at least about 25% (by volume) (e.g., 25-100%) after compression at about 35 kPa, and a compression modulus of at least about 1000 kPa. Examples of suitable polymers include polyurethanes, polymelamines, polyethylenes, polyesters, polysulfones, polyvinyl acetates, polyacrylic acids, polyacrylamides, polyvinylchlorides, polyvinylfluorides, polycarbonates, polyamides, polyethers, polystyrenes, polypropylenes, nylons, fluorinated hydrocarbons, and the like, and mixtures, copolymers, and grafts thereof. Preferably, the polishing pad comprises a polyurethane polishing surface. The polishing pad and/or surface can be formed from such materials using suitable techniques recognized in the art, for example, using thermal sintering techniques. Furthermore, the polishing pad formed from such materials can be substantially porous (i.e, having open or closed pores) or substantially non-porous. Porous pads preferably have a pore diameter of about 1-1000 μm and a pore volume of about 15-70%. The polishing pad and/or surface also can be perforated or unperforated to any degree. Preferably, the polishing pad comprises a perforated polishing surface.

The polishing surface of the polishing pad can comprise a multiplicity of cavities which can include and/or be in addition to any pores or perforations as previously described. Cavities include recesses or indentations in the surface of the pad, protrusions arranged in such fashion as to form recesses between the protruding portions of the surface of the pad, or any combination of recesses and protrusions. The recesses or protrusions can be any suitable size or shape. The multiplicity of cavities form a macro-texture on the polishing surface of the polishing pad, which can further include a micro-texture imposed upon the recessed and/or protruding portions of the macro-texture. The multiplicity of cavities forming the macro-texture and/or micro-texture can have any dimension and arrangement. The cavities can, for example, be arranged randomly or as a pattern.

The polishing pad optionally comprises a backing. The backing portion can comprise any suitable backing material known in the art. The backing can, for example, be flexible or rigid in varying degrees, as will be appreciated by those of ordinary skill in the art. Typical backing materials, for example, include polymeric films, metal foils, cloth, paper, vulcanized fiber, and combinations thereof.

The polishing pad can comprise fixed abrasive particles on or within the polishing surface of the polishing pad, or the polishing pad can be substantially free of fixed abrasive particles. Fixed abrasive polishing pads include pads having abrasive particles affixed to the polishing surface of the polishing pad by way of an adhesive, binder, ceramer, resin, or the like or abrasives that have been impregnated within a polishing pad so as to form an integral part of the polishing pad, such as, for example, a fibrous batt impregnated with an abrasive-containing polyurethane dispersion. Fixed abrasive pads can eliminate the need for providing an abrasive component in the polishing or cleaning composition.

### System Control

The present invention preferably utilizes a control device whereby the parameters of the delivery process can be centrally or automatically controlled. Examples of parameters that can be controlled by such a device include the flow rate of the components, the combination rate of the components, the rate of delivery of any one or more components (alone or in combination) to the polishing station (e.g., the ratio of components), the pH of the composition delivered to the point-of-use, the temperature of any of the components or the slurry at the point-of-use, the pressure of the system, and the speed and direction of rotation of the platen and/or carrier.

Preferably, the control device comprises an integrated circuit (e.g., a dedicated or external microprocessor) that communicates with one or more other devices used in the present invention (e.g., via electrical or electromechanical connections), for example, with the sensors, pumping device, flow valves, platen drive motor, carrier drive motor, etc. The control device, for example, can accept signals or data from sensors located at any point or throughout the process of the present invention. These signals or data can be used to monitor the parameters of the system (e.g., display the parameters to the system operator). An operator then is able to adjust the various process parameters by adjusting the flow valves, pumping device, mixing device, platen or carrier drive motors, or other various elements of the system via the control device. Alternatively, the control device can automatically adjust these various process parameters or system elements to maintain or achieve certain pre-set parameters (e.g., ranges of component ratios or concentrations).

The control device allows the amount of each component to be adjusted during the polishing and/or cleaning of the substrate manually or automatically (e.g., in response to a change in one or more parameters of the polishing and/or cleaning process). For example, the control device can be pre-programmed to deliver a particular ratio or concentration of the components used in the system, such as any particular ratio or concentration corresponding to any one or more of the polishing or cleaning compositions described herein. By communicating with the system via the sensors and/or flow valves, pumping devices, mixing devices, etc., the control device can maintain the pre-programmed settings, or the control device can change the settings depending on the particular needs of the polishing or cleaning process as determined from the signals or data communicated via the sensors. The control device can, for example, adjust the flow of one or more of the components delivered to the polishing station.

Moreover, the control device can monitor and control the parameters of the system, as discussed above, with respect to more than one polishing station so as to allow the polishing or cleaning of two or more substrates simultaneously with a single apparatus using the same or different polishing and/or cleaning compositions at each polishing station. For example, if two polishing stations are being used simultaneously, the polishing process being performed at each polishing station can have different demands (e.g., require different polishing or cleaning compositions). The control device can monitor and control the parameters of each polishing station independently to facilitate the performance of different polishing or cleaning operations at each station (e.g., the polishing of different substrates and/or the use of different polishing and/or cleaning compositions at each station).

The system (e.g., the various elements and controls of the system described herein) are preferably configured to allow a rapid, inexpensive changeover in chemistries (e.g., polishing and/or cleaning solutions). For example, for applications wherein different polishing or cleaning processes are to be performed using the same tool (i.e., polishing station), the apparatus can be configured to provide a flushing mechanism by which the various elements of the system (e.g., the flow lines, mixing device, dispenser, etc.), and/or the substrate being polished, are flushed with an appropriate fluid prior to changing the formulation of the polishing or cleaning composition. Appropriate fluids for such use are generally known in the art and include deionized water as well as various organic and inorganic solvents.

### Exemplary Apparatus

Suitable apparatus and elements thereof (e.g., storage devices, flow lines, valves, pumping devices, measuring devices, mixing devices, sensors, dispensers, and/or polishing stations) for use in the present invention include those described in U.S. Pat. Nos. 4,059,929, 5,148,945, 5,330,072, 5,407,526, 5,478,435, 5,540,810, 5,664,990, 5,679,063, 5,750,440, 5,803,599, 5,874,049, 5,994,224, and 6,040,245, as well as International patent application Nos. PCT/US99/00291 (WO 99/34956) and PCT/US97/17825 (WO 98/14305).

All of the references cited herein, including patents, patent applications, and publications, are hereby incorporated in their entireties by reference. While this invention has been described with an emphasis upon preferred embodiments, it will be obvious to those of ordinary skill in the art that variations of the preferred embodiments may be used and that it is intended that the invention may be practiced otherwise than as specifically described herein. Accordingly, this invention includes all modifications encompassed within the spirit and scope of the invention as defined by the following claims.

What is claimed is:

1. A method of polishing and/or cleaning two or more substrates simultaneously comprising (i) providing two or more substrates, (ii) providing two or more storage devices each containing a component of a multi-component polishing and/or cleaning composition, (iii) delivering the components for the polishing and/or cleaning compositions from two or more of the storage devices to each substrate, and (iv) polishing and/or cleaning the two or more substrates simultaneously, wherein the polishing and/or cleaning compositions as delivered to at least two of the substrates are different and have at least one component in common delivered from the same storage device.

2. The method of claim 1, wherein the substrates are different.

3. The method of claim 1, wherein the substrates are the same.

4. The method of claim 1, wherein at least one substrate is a semiconductor device.

5. The method of claim 4, wherein at least two substrates are semiconductor devices which are at different stages of production.

6. The method of claim 1, wherein at least one substrate is a rigid or memory disk.

7. The method of claim 1, wherein the components of the different polishing and/or cleaning compositions are mixed at the point-of-use or immediately before delivery to the point-of-use.

8. The method of claim 1, wherein the components of the different polishing and/or cleaning compositions are provided continuously.

9. The method of claims 1, wherein the amounts of the components are adjusted during the polishing or cleaning processes.

10. The method of claim 9, wherein the amounts of the components are adjusted in response to a change in one or more parameters of the polishing and/or cleaning process.

11. The method of claim 10, wherein the one or more parameters comprise at least one selected from the group consisting of the thickness of the substrate, the pH of the polishing composition, the uniformity of the substrate, the friction between the polishing pad and the substrate, and the electrical conductivity of the substrate.

12. The method of claim 9, wherein the formulation of each of the polishing or cleaning compositions is adjusted independently of one another.

13. The method of claim 1, wherein at least one polishing composition is delivered to at least one substrate.

14. The method of claim 13, wherein at least one substrate comprises a metal, a metal alloy, or a metal composite.

15. The method of claim 13, wherein at least one substrate comprises copper or a copper alloy.

16. The method of claim 13, wherein at least one substrate comprises tantalum or tantalum nitride.

17. The method of claim 13, wherein at least one substrate comprises a semiconductor base material.

18. The method of claim 13, wherein at least one substrate comprises dielectric film.

19. The method of claim 13, wherein at least one substrate comprises a metal oxide.

20. The method of claim 13, wherein at least two polishing compositions are delivered to at least two substrates.

21. The method of claim 1, wherein at least one cleaning composition is delivered to at least one substrate.

22. The method of claim 21, wherein at least two cleaning compositions are delivered to at least two substrates.
